(19) United States
(12) Patent Application Publication
(10) Pub. No.: US 2004/0237403 A1
(43) Pub. Date: Dec. 2, 2004

(54) Plant cultivation device

(76) Inventors: Shinji Sekiya, Tokyo (JP); Kae Saiki, Kanagawa (JP)

Correspondence Address: Weingarten Schurgin Gagnebin & Lebovici, Ten Post Office Square, Boston, MA, 02109, US

(21) Appl. No.: 10/493,775

(22) PCT Filed: Oct. 16, 2002
(86) PCT No.: PCT/JP02/10768

(30) Foreign Application Priority Data
Oct. 26, 2001 (JP) 2001-329182

(51) Int. Cl. A01G 25/00

(52) U.S. Cl. 47/81

(57) ABSTRACT

The invention provides a plant cultivation device with a double pot structure, which adjustably feeds an appropriate amount of cultivation water inherently necessary corresponding to plant types, and which adjustably feeds the cultivation water corresponding to environments or seasons wherein the plant is cultivated. Inner pot are constructed by facing bottom faces of a pair of vessels, wherein a locking projection and a locking groove positioned on the same periphery as the locking projection are formed in a state that they protrude from the outer periphery of a bottom part of a main body of the vessel, and a through hole in which a water absorption body is installed is formed at the bottom part of the main body, and by integrating the vessels by engaging the respective locking projections with the respective locking grooves each other. The inner pot is housed in an outer pot.

### TECHNICAL FIELD

The present invention relates to a plant cultivation device with a double pot structure, which is suitable as a plant pot for fancy plants, a container placed on a rooftop terrace or a terrace garden, a planter for growing crops and the like, and more particularly, to new constructions of an inner pot.

### BACKGROUND ART

Conventionally, various devices, with which daily hand watering labor is saved in plant cultivation by a plant pot etc. have been developed. However, applicants of the invention have developed a plant cultivation device with a double pot structure using a capillary action body, and have made the device serve in practical use.

FIG. 11 is an example of the plant cultivation devices with a double pot structure by the applicants of the invention. In this device, a main body comprises an inner pot 101 and an outer pot 102 having a size to surround the whole inner pot. The inner pot 101 is placed on a base 103. A water retention body 104 is arranged at a feed water hole 101A opened through the bottom part of the inner pot 101. A feeder 105, whose top contacts the water retention body is arranged.

In the plant cultivation vessel with a double pot structure constructed as above, cultivation water W from the feeder 105 into the inner pot 101 can be fed stably over long periods. In addition, the inner pot 101 can be covered by the outer pot 102, so that a material for the outer pot 102 can be selected voluntarily, and design flexibility can be improved.

In the foregoing construction, design in appearance can be improved, and feed water over long periods is available. That is, effect of a so-called maintenance free can be improved. However, various plants have individual characteristics. Those characteristics are subtly different from each other. For example, some plants require much water, but some plants grow well with a modest amount of water. Therefore, it is an important task to feed respective plants with an appropriate amount of water.

For many plants, for example, a necessary amount of water in the summer season is different from in the winter season. In addition, dryness degrees of potting compost vary depending on whether the plant is cultivated indoors or outdoors. Therefore, it has been significantly hard to retain appropriate moisture constantly. Particularly, in the conventional plant cultivation device with a double pot structure as shown in FIG. 11, a feed rate of the cultivation water from the feed water hole is always constant. It is not possible to change the feed rate of the cultivation water even when changing the cultivated plant. Further, the conventional plant cultivation device has not been constructed to adjust its feed rate of the cultivation water corresponding to change of the environments such as indoor and outdoor, change of the seasons and the like.

### DISCLOSURE OF INVENTION

In light of the foregoing conventional problems, it is an object of the invention to enable to feed the appropriate amount of cultivation water inherently necessary corresponding to respective plant types, and to feed the cultivation water corresponding to respective environments and seasons wherein the plant is cultivated. Further, it is another object of the invention to enable reduction of manufacturing cost by constructing inner pots by a pair of cultivation vessels formed integrally.

The invention resolves the foregoing issues by the following constructions: a first construction, a plant cultivation device comprising an inner pot constructed by a vessel, wherein the vessel has a locking projection and a locking groove positioned on the same periphery as the locking projection are formed in a state that they protrude from the outer periphery of a bottom part of a main body of the vessel and a through hole in which a water absorption body is installed is formed on the bottom part of the main body; a second construction, wherein the through hole in which the water absorption body is installed has a shape whose opening direction is variable depending on angles in the foregoing first construction; a third construction, a plant cultivation device comprising an inner pot constructed by vertically facing bottom faces of a pair of vessels and housed in an outer pot, wherein each vessel has a locking projection and a locking groove positioned on the same periphery as the locking projection are formed in a state that they protrude from the outer periphery of a bottom part of the main body of the vessel, and a through hole in which the water absorption body is installed is formed at the bottom part of the main body, and by integrating the pair of vessels by engaging the respective locking projections with the respective locking grooves each other the water absorption bodies of the upper and lower vessels are contacted with each other; a fourth construction, wherein a feed rate of water to a plant cultivation vessel of the inner pot can be adjusted by adjusting an engaging angle between the bottom faces in the inner pot in the foregoing third construction; and a fifth construction, wherein a degree of the contact area between the water absorption bodies at the bottom faces in the inner pot can be visually recognized in the foregoing third construction.

### BRIEF DESCRIPTION OF DRAWINGS

FIG. 1 is a longitudinal sectional view, which shows a construction of a plant cultivation device of the invention;

FIG. 2 is an oblique perspective figure of a vessel of a component of the plant cultivation device of the invention;

FIG. 3 is an oblique perspective figure, which shows a construction of a bottom face of the vessel shown in FIG. 2;

FIG. 4 is a view, which shows a condition to assemble inner pots by the vessels shown in FIG. 2;

FIGS. 5A, 5B, and 5C are pattern diagrams to explain contact areas between respective water absorption bodies of the plant cultivation device of the invention;

FIG. 6 is an oblique perspective figure, which shows a construction example to recognize a degree of the contact area between the respective water absorption bodies;

FIG. 7 is an oblique perspective figure, which shows other construction example to recognize a degree of the contact area between the respective water absorption bodies;

FIG. 8 is an oblique perspective figure, which shows other construction example of a vessel of a component of the plant cultivation device of the invention;

FIG. 9 is a view, which shows a condition to assemble inner pots by the vessels shown in FIG. 8;

FIGS. 10A, 10B, and 10C are pattern diagrams to explain contact areas between the respective water absorption bodies of the plant cultivation device according to the vessels shown in FIG. 8, and

FIG. 11 is a longitudinal sectional view, which shows a construction of a conventional plant cultivation device.

### EXPLANATION OF NUMERAL

A1, A2 vessels

B outside pot

C1, C2 water absorption bodies

1 main body

2 stems

3 outer ring

4 locking projection

4A neck part

5 locking groove

6 through hole

7 retainer plate

8 vent

9 vent path

10 concave part

12 drain hole

13 adjustment mark

14 marker

15 concave part

### BEST MODE FOR CARRYING OUT INVENTION

Next, descriptions will be given of an embodiment of the invention. Descriptions will be given of an embodiment of the invention by taking a plant pot as a representative example. However, the invention can be widely applied as a plant cultivation device. In addition, an application target is not subject to its size.

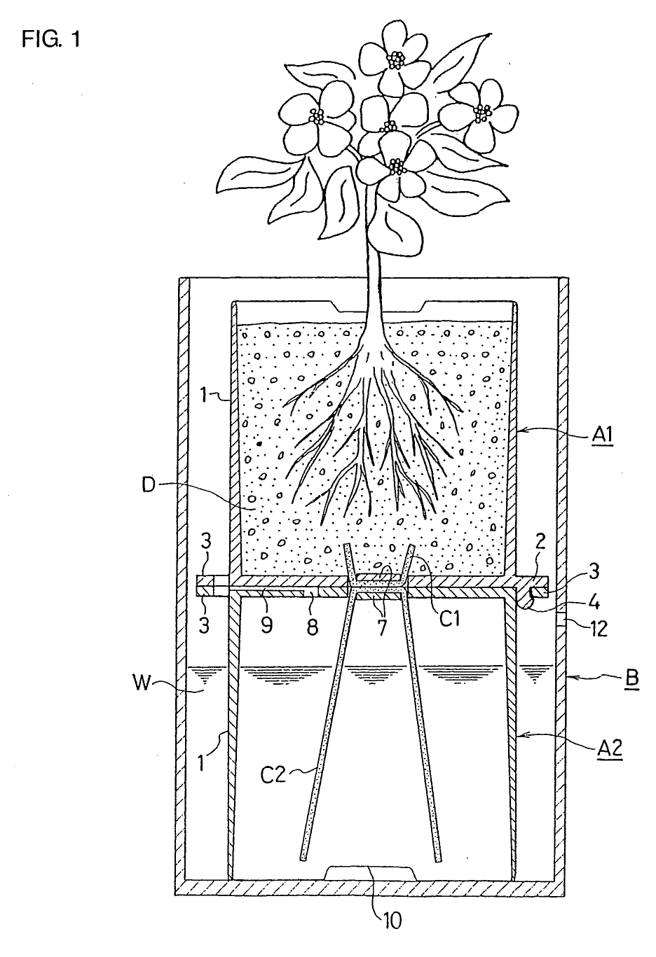

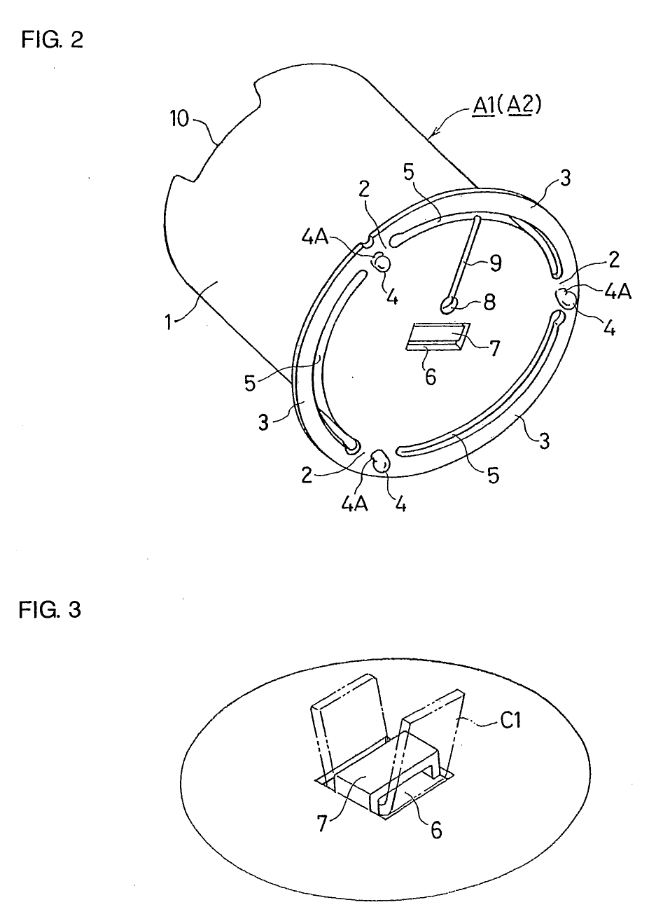

FIG. 1 is a longitudinal sectional view, which shows a complete condition of the plant cultivation device of the invention. In this figure, a pair of vessels A1, A2 having the same construction, which becomes inner pots is constructed so that respective bottom faces are contacted with each other and are attachable/detachable to/from each other. That is, as shown in FIG. 2, the vessel A1/A2 forms a main body 1 in a shape with a bottom similar to general plant pots. In the vessel A1/A2, a given number (three in this embodiment) of stems 2 sent out from the bottom part of the main body and an outer ring 3 connected with an end of the stem are integrally formed by using a synthetic resin material etc. A locking projection 4 wherein a neck part 4A is formed by under cut is formed integrally with the stem 2. Arrangement is made so that a space formed between an outer periphery of the bottom face formed in a flat shape of the main body 1 and an inner periphery of the outer ring 3 is a locking groove 5, which engages with the locking projection 4.

On the bottom face of the vessel A1/A2, a through-hole 6 to confront water absorption bodies made of a nonwoven cloth etc. is formed. As shown in FIG. 3, a retainer plate 7 is formed integrally with the through hole inside the vessel. The through hole 6 needs to have a shape whose opening directions are changed depending on angles. In this embodiment, the through hole 6 is formed in a rectangle shape. A short water absorption body C1 is inserted through the through hole 6 of the upper vessel A1, and a long water absorption body C2 is inserted through the through hole 6 of the lower vessel A2. The water absorption bodies C1, C2 are thereby exposed at the bottom faces of the vessels A1, A2, and become available to contact with each other. It becomes possible to prevent root hairs of the cultivated plant from intruding into the lower vessel A2 through the through hole 6 by firstly installing the short water absorption body C1 through the through hole 6 of the upper vessel A1, and then providing a water absorption filter covering an inner bottom face of the vessel A1.

Numeral 8 represents a vent. Air discharge and intake of the vessel A1/A2 is available through a vent path 9 formed by caving the bottom face of the vessel A1/A2. Numeral 10 is a concave part formed at an opening edge of the vessel A1/A2. Cultivation water W can flow through the concave part. Numeral B is an outside pot to reserve the cultivation water W and house the inner pots. The outer pot comprises a drain hole 12 to prevent reserving the cultivation water more than necessary.

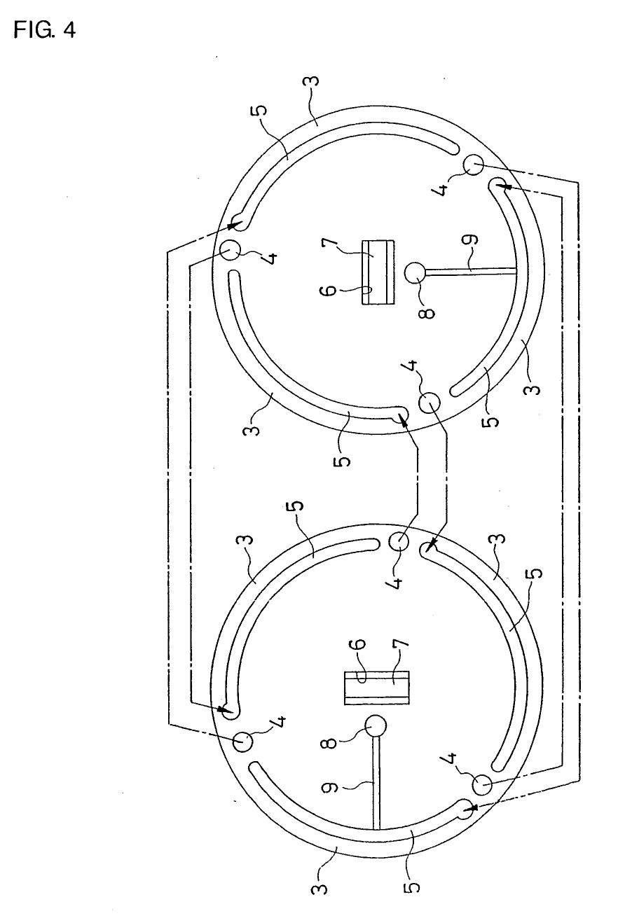

Assembling the pair of vessels A1, A2 constructed as above as shown in FIG. 1 is made as follows. That is, respective bottom faces of the vessels A1, A2 are faced, and as shown in FIG. 4, the locking projection 4 of one vessel is inserted into the end part of the corresponding locking groove 5 of the other vessel respectively. While the respective bottom faces are contacted with each other, respective vessels are rotated in the opposite direction of each other. The locking projection 4 and the locking groove 5 are thereby engaged with each other, and the upper and lower vessels A1, A2 are integrated.

As above, the inner pots are constructed by the upper and lower vessels A1, A2, the inner pots are housed in the outer pot B as shown in FIG. 1, and then the cultivation water W is filled. The cultivation water W is firstly absorbed in the water absorption body C2, and then is absorbed up into the top of the water absorption body C2, that is a part of the water absorption body C2 which is exposed at the bottom face of the vessel A2 by the capillary action. The cultivation water W is thereby absorbed in the water absorption body C1 which is exposed at the bottom face of the upper vessel A1 and which contacts with the water absorption body C2. The cultivation water W is released from this water absorption body C1 to potting compost D in the vessel A1, and feed water is performed.

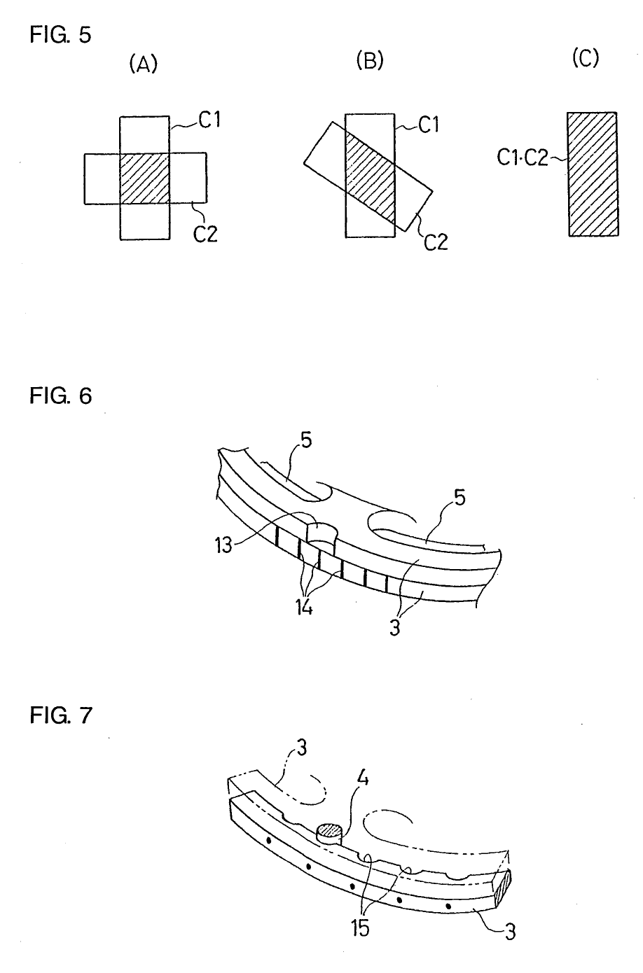

Descriptions will be given hereinafter of a case wherein a feed rate is adjusted according to conditions of cultivated plants, or environmental conditions. When the upper and lower vessels A1, A2 are integrated as described before based on FIG. 4, but the upper and lower vessels A1, A2 are not rotated, a contact area between the water absorption bodies C1 and C2 is a minimum as shown by a shaded area in FIG. 5A. Along with rotation of the vessels, the contact area becomes large gradually as shown in FIG. 5B, and the contact area finally becomes maximum as shown in FIG. 5C. Therefore, it is possible to voluntarily adjust a feed rate to the plant by selecting a size of this contact area as appropriate.

FIG. 6 shows a construction which enables to visually recognize a degree of the contact area between the water absorption bodies C1 and C2. An adjustment mark 13 is formed on the outer ring 3 of the upper vessel A1, and a marker 14 is provided on the outer ring 3 of the lower vessel A2. It is possible to indirectly recognize the contact area between the water absorption bodies C1 and C2 by a relative position of the adjustment mark 13 in relation to the marker 14. FIG. 7 shows a construction, wherein a plurality of concave parts 15 is formed with a given pitch inbetween at an inner periphery of the outer ring 3 of the lower vessel A2. In this construction, the locking projection 4 is stopped (so-called click stopped) intermittently at this concave part 15. Therefore, it is possible to indirectly recognize the contact area between the water absorption bodies C1 and C2 at a given rotation stop position.

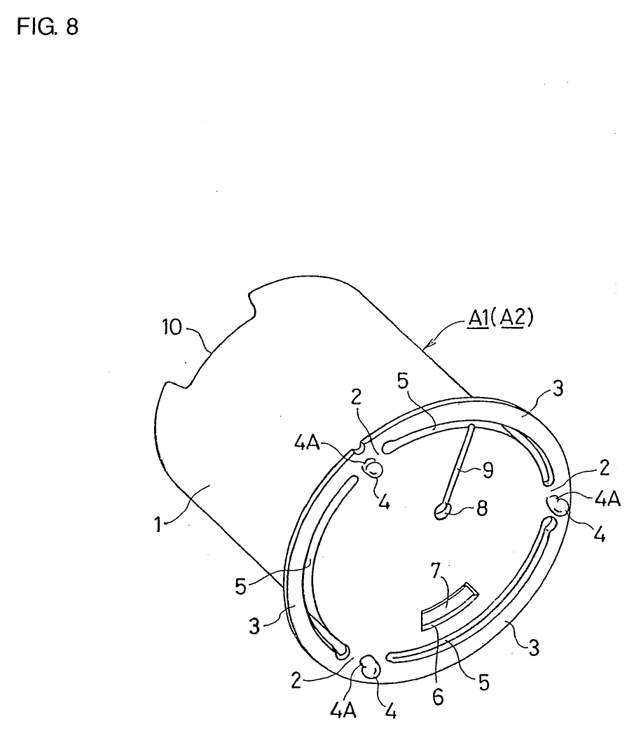

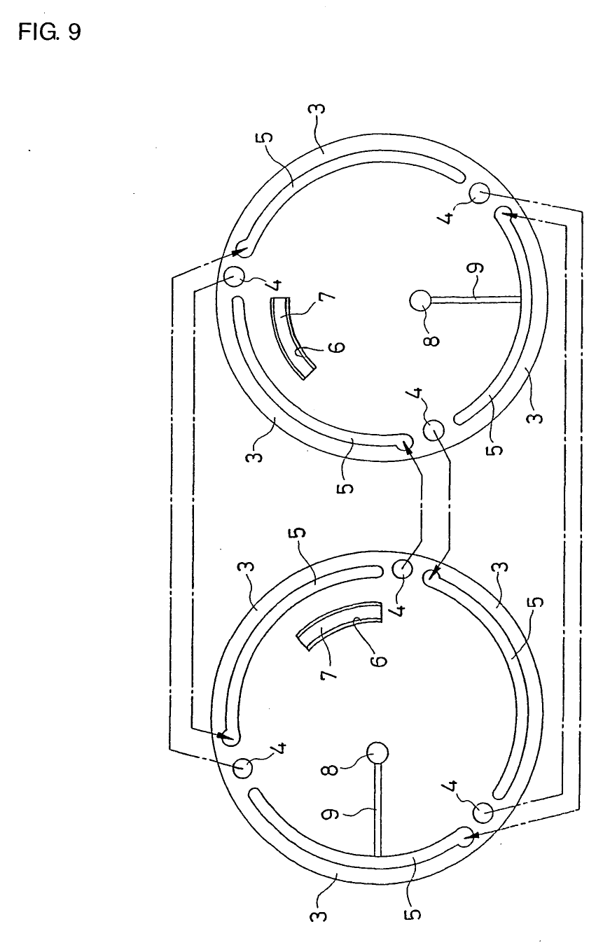

FIG. 8 shows other construction example of vessels of the invention. In this construction, the through hole 6 and the retainer plate 7 are formed on the outer periphery side of the bottom face of the vessel A1/A2. Assembling the vessels A1, A2 is made as follows. That is, respective bottom faces of the vessels A1, A2 are faced, and as shown in FIG. 9, the locking projection 4 of one vessel is inserted into the end part of the corresponding locking groove 5 of the other vessel respectively. While the respective bottom faces are contacted with each other, respective vessels are rotated in the opposite direction of each other. The locking projection 4 and the locking groove 5 are thereby engaged with each other, and the upper and lower vessels A1, A2 are integrated.

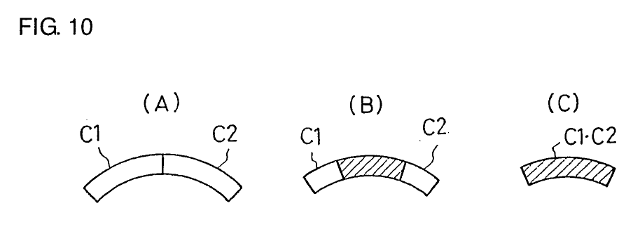

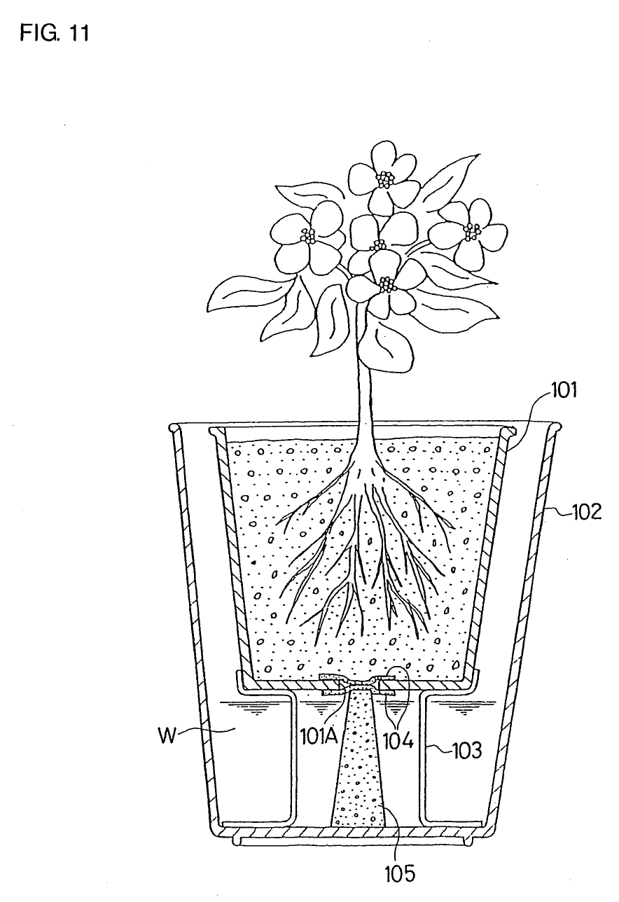

In the process that the upper and lower vessels A1, A2 are integrated as above, when the vessels are initially rotated in the opposite direction of each other, the water absorption bodies C1, C2 rarely contact with each other as shown in FIG. 10A. Along with rotating the vessels A1, A2, the contact area between the water absorption bodies C1 and C2 becomes large gradually as shown in FIG. 10B, and the contact area finally becomes maximum as shown in FIG. 1° C. Therefore, it is possible to voluntarily adjust a feed rate to the plant by selecting a size of this contact area as appropriate.

### INDUSTRIAL APPLICABILITY

As described in detail above, according to the plant cultivation device of the invention, an appropriate amount of cultivation water inherently necessary corresponding to plant types can be adjustably fed, and the cultivation water can be adjustably fed corresponding to environments or seasons wherein the plant is cultivated. Further, according to the invention, the inner pots can be constructed by a pair of vessels which are formed integrally. Therefore, manufacturing cost can be reduced.

1. A plant cultivation device comprising an inner pot constructed by a vessel, wherein the vessel has a locking projection and a locking groove positioned on the same periphery as the locking projection are formed in a state that they protrude from the outer periphery of a bottom part of a main body of the vessel and a through hole in which a water absorption body is installed is formed on the bottom part of the main body.

2. A plant cultivation device according to claim 1, wherein the through hole in which the water absorption body is installed has a shape whose opening direction is variable depending on angles.

3. A plant cultivation device comprising an inner pot constructed by vertically facing bottom faces of a pair of vessels and housed in an outer pot, wherein each vessel has a locking projection and a locking groove positioned on the same periphery as the locking projection are formed in a state that they protrude from the outer periphery of a bottom part of a main body of the vessel, and a through hole in which the water absorption body is installed is formed at the bottom part of the main body; and by integrating the pair of vessels by engaging the respective locking projections with the respective locking grooves each other the water absorption bodies of the upper and lower vessels are contacted with each other.

4. A plant cultivation device according to claim 3, wherein a feed rate of water to a plant cultivation vessel of the inner pot can be adjusted by adjusting an engaging angle between the bottom faces in the inner pot.

5. A plant cultivation device according to claim 3, wherein a degree of the contact area between the water absorption bodies at the bottom faces in the inner pot can be visually recognized.

6. A plant cultivation device according to claim 3, wherein the water absorption body is installed on the bottom part of the upper vessel, and a water absorption filter covering an inner bottom face of the vessel is provided.
